(19) United States
(12) Patent Application Publication
(10) Pub. No.: US 2008/0216558 A1
(43) Pub. Date: Sep. 11, 2008

(54) Saw based CO2 sensors using carbon nanotubes as the sensitive layer

(75) Inventors: Sarin Anakkat Koyilothu, Bangalore (IN); Raju A. Raghurama, Bangalore (IN)

Correspondence Address: Bryan Anderson;Attoney, Intellectual Property, Honeywell International Inc., 101 Columbia Rd., P.O. Box 2245, Morristown, NJ, 07962, US

(73) Assignee: Honeywell International

(21) Appl. No.: 11/716,215

(22) Filed: Mar. 8, 2007

(51) Int. Cl. G01N 29/024

(52) U.S. Cl. 73/24.06; 73/31.04; 977/720

(57) ABSTRACT

A surface acoustic wave based CO₂ sensor using carbon nanotubes as the sensitive layer fabricated by combining surface acoustic wave (SAW) devices and nanotechnology. The device structure consists of the gas sensitive material between the input and output interdigital transducers (IDTs) of a SAW device. The CO₂ gas gets adsorbed on nanotubes when the carbon nanotube based SAW sensor is exposed to CO₂ at room temperature and/or at elevated temperature, which in turn changes conductivity of the carbon nanotube. This conductivity change will affect the velocity of the SAW traveling across the nanotubes and will give a frequency change which corresponds to the percentage of the CO₂ molecules adsorbed by the nanotubes.

### TECHNICAL FIELD

Embodiments are generally related to gas sensors. Embodiments are also related to the field of surface acoustic wave (SAW) based CO₂ sensors. Embodiments are additionally related to CO₂ sensors using carbon nanotubes as the sensitive layer, either alone or in conjunction with organic or inorganic materials to improve the sensitivity and selectivity.

### BACKGROUND OF THE INVENTION

Gas sensors are used in many industrial, medical, and commercial applications. For example, oxygen sensors are used in the monitoring of combustion engine environments to increase engine performance and reduce emission of green house gases. Ammonia sensors are important for monitoring ambient ammonia concentration since it is related to many environmental issues such as acidification, human health and climate change through particle formation. In addition to controlling industrial processes and monitoring air quality, CO₂ sensors are also widely used in food and medicine packages as means of detecting spoilage. Most gas sensors available in the market today are either optical based or operate by measuring the impedance of a capacitor coated with a gas responsive polymer(s) or ceramic such as heteropolysiloxane, BaTiO₃, CeO₂/BaCO₃/CuO, Ag₂SO₄, Na₂CO₃ and SnO₂ etc.

Low cost CO₂ sensors are very important for indoor air quality monitoring, medical applications and also for environmental CO₂ monitoring. Most of the present day commercially available CO₂ sensors are infrared sensors and are very expensive. Apart from these devices, there are reports about the fabrication of CO₂ sensors based on metal oxide semiconductors, which operate only at high temperature. This shows the importance for an alternative technology for fabricating low cost CO₂ sensors which operate at room temperature and/or at elevated temperature.

The application of multiwall carbon nanotubes for remote query detection of carbon dioxide, oxygen, and ammonia based upon the measured changes in multiwall nanotubes permittivity and conductivity with gas exposure has been reported. In the prior art the sensor consists of a printed inductor-capacitor resonant circuit that is first coated with a protective, electrically insulating SiO₂ layer followed by a second layer of gas-responsive multiwall carbon nanotubes-SiO₂ mixture with the SiO₂ matrix acting to physically bind the multiwall carbon nanotubes to the sensor.

A CO₂ sensor made up of a substrate and a nanostructure disposed over the substrate where in the nanostructure comprises of a carbon nanotube or a network of nanotubes is also reported. Here two conductive elements are disposed over the substrate and electrically connected to the nanotube. This sensor is fabricated using field-effect transistor based device design.

Gas sensors can be fabricated by combining surface acoustic wave (SAW) devices and nanotechnology. The SAW devices are known to be highly sensitive to the slightest changes happening on the piezoelectric substrate surface, and the carbon nanotubes are highly desirable for adsorption and detection of gases due to their hollow centre, nanometer size, and large surface area. Hence it is believed that the combination of these two technologies together with other organic or inorganic materials or a mixture of both organic and inorganic materials will result in highly sensitive devices.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved surface acoustic wave (SAW) based CO₂ sensors that can operate at room temperature and/or at elevated temperature.

It is another aspect of the present invention to provide for CO₂ sensors using carbon nanotube as the sensitive layer.

The aforementioned aspects and other objectives and advantages can now be achieved as described herein. Sensors are fabricated by combining SAW devices and nanotechnology. The device structure in general consists of the gas sensitive material between the input and output interdigital transducers (IDTs) of a SAW device. Carbon nanotubes are used as the gas sensitive material for CO₂. The CO₂ gas gets adsorbed on nanotubes when the carbon nanotube based SAW sensor is exposed to CO₂ at room temperature, which in turn changes conductivity of the carbon nanotube. This conductivity change will affect the velocity of the SAW traveling across the nanotubes and will give a frequency change which corresponds to the percentage of the CO₂ molecules adsorbed by the nanotubes.

To fabricate the prototype of the above mentioned devices, the first step in general is to deposit the nanotubes directly on to a piezoelectric substrate, for example LiNbO₃ or Quartz. The nanotube deposition can be carried out by any of the methodologies available in the literature. After the deposition, the nanotubes strip can be patterned. Then the input and output IDTs can be deposited with nanotubes strips laying exactly between them. All these process can be carried out by the standard photolithographic technique using positive or negative photo resist. Characterization of the prototype device can be carried out using an oscillator circuit and impedance analyzer

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic diagram of the SAW based CO₂ sensor using carbon nanotubes as the sensitive layer which can be implemented in accordance with a preferred embodiment;

FIG. 2 illustrates a schematic diagram of the piezoelectric substrate on which the carbon nanotubes are deposited which can be implemented in accordance with a preferred embodiment; and

FIG. 3 illustrates a flowchart of operations depicting logical operational steps for the detection of CO₂ using SAW based CO₂ sensor, in accordance with a preferred embodiment.

### DETAILED DESCRIPTION

The particular values and configurations discussed in these non-limiting examples can be varied and are cited merely to illustrate at least one embodiment and are not intended to limit the scope thereof.

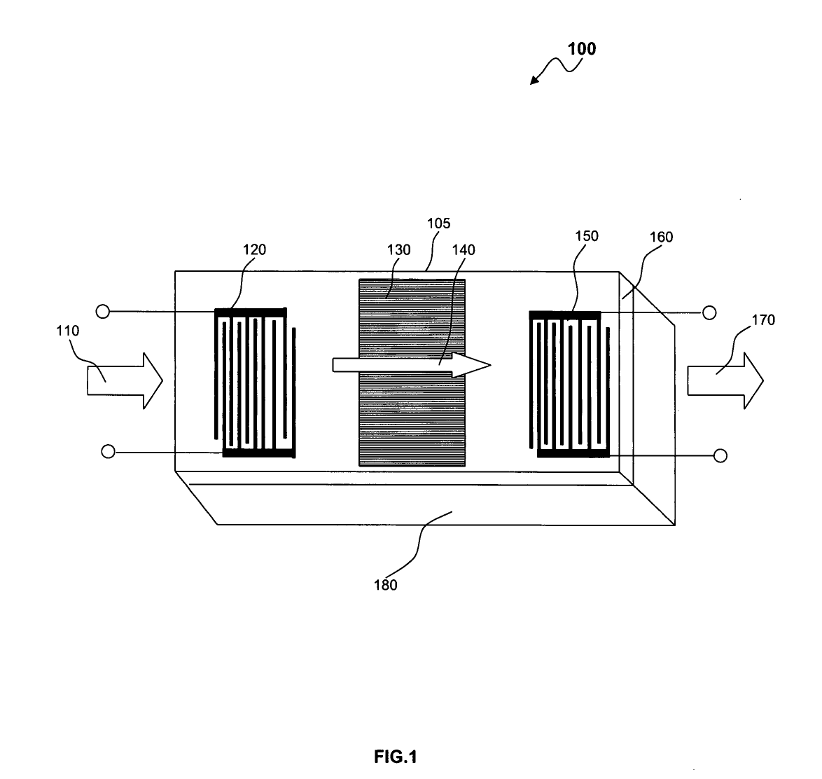

Referring to FIG. 1, a schematic diagram 100 of the SAW based CO₂ sensor device 105 is illustrated, which can be implemented in accordance with a preferred embodiment. The SAW based CO₂ sensor device 105 comprises a piezoelectric substrate 160, for example LiNbO₃ or quartz. The Carbon nanotube material 130 can be deposited on the piezoelectric substrate 160. After the deposition, the carbon nanotubes material 130 can be patterned in the form of stripes running parallel with flow as shown in FIG. 1. The carbon nanotube material 130 can also be deposited in the form of stripes forming a stripe-like layer on top of the substrate 160. A metallic input inter digital transducer 120 and an output inter digital transducer 150 can each be deposited with the carbon nanotube material 130 laying exactly between them.

The CO₂ sensor device 105 can be standardized by applying an electric signal 110 to the input inter digital transducer 120. The input signal causes a surface acoustic wave 140 to be induced in the piezoelectric substrate 160 and propagate towards the output inter digital transducer 150. The shape of the generated surface acoustic wave 140 depends on the electric signal applied to the input inter digital transducer 120, the design and orientation of inter digital transducer fingers, and the piezoelectric material used. When the wave reaches the output inter digital transducer 150 a voltage is induced across the fingers of the interdigital transducer 150 which is then represented by an output signal 170 from the device. The shape of the output wave is affected by the design of the output inter digital transducer 150. The CO₂ gas gets adsorbed on the carbon nanotube material 130 when the CO₂ sensor device 100 is exposed to CO₂ at room temperature. As a result the velocity of the surface acoustic wave 140 traveling across the nanotubes can be changed either due to the mass loading effect or electro acoustic interaction which in turn gives rise to a change in output 170 from the device. This change corresponds to the percentage of the CO₂ molecules adsorbed by the nanotubes.

A similar idea can be worked out with the nanotubes or wires of the oxide or non-oxide semiconductors. Other than carbon nanotubes, the nanotubes can be made of any one or a combination of: silicon, oxide, gallium, nitride, silver, and other known semiconductors. Alternatively the SAW based device 105 can be comprised of SiO₂ protective layer only on top of the input and output inter digital transducers 120 and 150. This will help to prevent the shorting of the device with the nanotubes deposited between the input and output interdigital transducers and thereby improve the sensitivity. This may also help to deposit the nanotubes on all over the piezoelectric substrate without restricting them only between the interdigital transducers. This may also reduce an additional photolithographic step in the whole process.

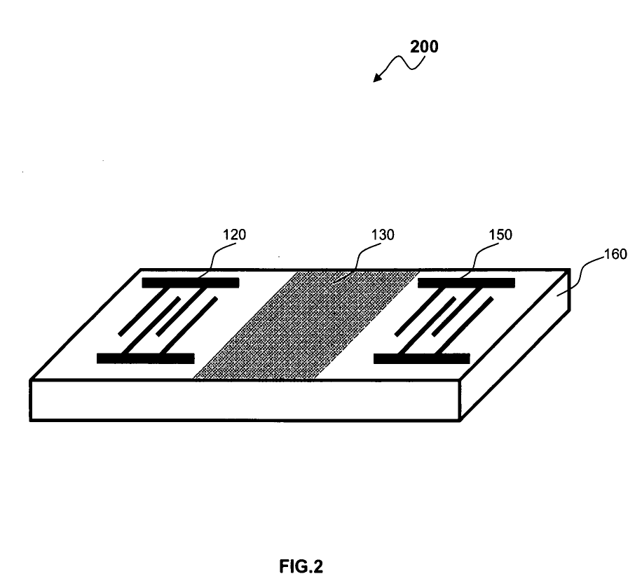

Referring to FIG. 2 illustrates schematic diagram 200 of the piezoelectric substrate 160 on which the carbon nanotubes 130 are deposited, which can be implemented in accordance with a preferred embodiment. In FIGS. 1 and 2, identical or similar parts or elements are generally indicated by identical reference numerals. To fabricate the prototype of the above mentioned device 105, the first step is to deposit the nanotubes material 130 directly on to a piezoelectric substrate 160, either LiNbO₃ or Quartz. The nanotube deposition can be carried out by any of the methodology available in the literature. After the deposition, the nanotube material 130 can be patterned. A logical pattern, again, is in the form of stripes; although other patterns may also be devised and found to work as a sensing medium. Patterning of stripes in FIG. 2 is such that the stripes run perpendicular to flow. After patterning, the input and output inter digital transducers 120 and 150 can be deposited at each side of the nanotube material 130. All these process can be carried out by the standard photolithographic technique using positive or negative photo resist. Characterization of the prototype device can be carried out using an oscillator circuit and impedance analyzer (not shown in figure).

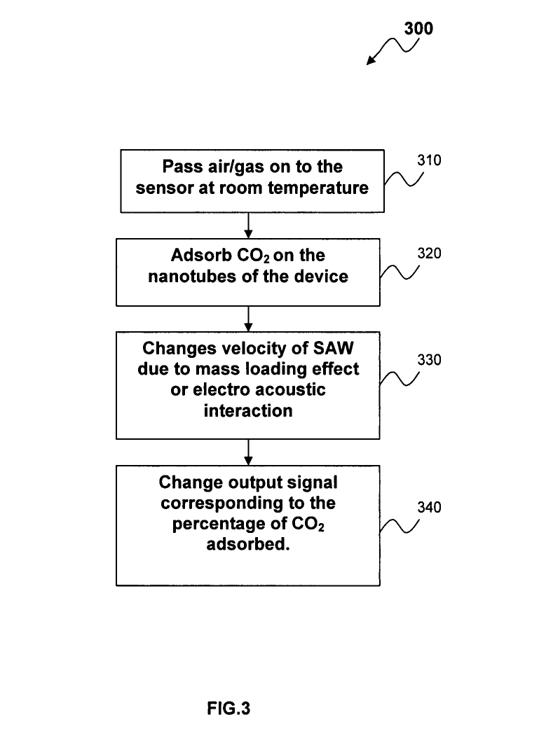

Referring to FIG. 3 a flowchart 300 of operations is illustrated depicting logical operational steps for the detection of CO₂ using SAW based CO₂ sensor, in accordance with a preferred embodiment. As indicated at block 310 gas or air can be passed onto the nanotube-based sensor. Next as depicted at block 320, CO₂ present in gas/air can get adsorbed by the nanotube material, the sensitive layer of the sensor. Next as depicted at 330 the velocity of the SAW traveling across the nanotubes can be changed either due to the mass loading effect or due to electro acoustic interaction. Finally as depicted at block 340 output signal can be changed corresponding to the percentage of CO₂ adsorbed.

The nanotube material can be formed of nanotubes including at least one material from the group comprising: heteropolysiloxane, nano-crystalline, BaTiO₃, CeO₂, BaCO₃, CuO, Ag₂SO₄, Na₂CO₃, SnO₂, BaTiO₃, La₂O₃, CaCO₃, CuO—SrTiO₃BaSnO₃, CuO—BaTiO₃, Sm₂O₃, and Y₂O₃. The nanotube material can also be formed of nanotubes including a combination of at least two materials from the group comprising: carbon, silicon, semiconducting oxides, gallium-nitride, and silver.

The surface acoustic wave CO₂ gas sensor can include a SiO₂ protective layer disposed on top of two metallic interdigital transducers to prevent them from shorting with each other or with said nanotube material deposited between said two metallic interdigital transducers. The surface acoustic wave CO₂ gas sensor can be provided in the form of a Rayleigh SAW (R-SAW) device. The surface acoustic wave CO₂ gas sensor can also be provided in the form of a shear horizontal SAW (SH-SAW) device

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A CO₂ gas sensor comprising:
a piezoelectric substrate;
nanotube material deposited directly onto a surface of said piezoelectric substrate; and
two metallic interdigital transducers deposited onto the piezoelectric substrate on each side of the nanotube material, said two metallic interdigital transducers adapted to react in operational combination with the nanotube material as a sensor of CO₂ gas when CO₂ gas becomes absorbed by the nanotube material.

2. The CO₂ gas sensor of claim 1, wherein said nanotube material is comprised of at least one of the group comprising: heteropolysiloxane, nano-crystalline, BaTiO₃, CeO₂, BaCO₃, CuO, Ag₂SO₄, Na₂CO₃, SnO₂, BaTiO₃, La₂O₃, CaCO₃, CuO—SrTiO₃, CuO—BaSnO₃, CuO—BaTiO₃, Sm₂O₃, and Y₂O₃.

3. The CO₂ gas sensor of claim 1, wherein said nanotube material is comprised of a combination of at least two of the group comprising: carbon, silicon, semiconducting oxides, gallium-nitride, and silver.

4. The CO₂ gas sensor of claim 1 wherein said SAW device is further comprised of SiO₂ protective layer disposed on top of two metallic interdigital transducers to prevent them from shorting with each other or with said nanotube material deposited between said two metallic interdigital transducers.

5. The CO₂ gas sensor of claim 1 wherein said SAW device is a Rayleigh SAW (R-SAW) device.

6. The CO₂ gas sensor of claim 1 wherein said SAW device is a shear horizontal SAW (SH-SAW) device.

7. The CO₂ gas sensor of claim 1 wherein said nanotube material is comprised of nanotubes formed in at least one of: single-wall orientation, double wall orientation, multi-wall orientation.

8. A surface acoustic wave CO₂ gas sensor comprising:
a piezoelectric substrate;
nanotube material deposited directly onto a surface of said piezoelectric substrate, wherein said nanotube material is adapted to change its conductive properties when it absorbes CO₂;
a first metallic interdigal transducer deposited onto the surface of the piezoelectric substrate on an upstream side of the nanotube material; and
a second metallic interdigital transducer deposited onto the surface of the piezoelectric substrate on a downstream side of the nanotube material;
wherein said first and second metallic interdigital transducers are adapted to react in operational combination with the nanotube material as a sensor of CO₂ gas when CO₂ gas becomes absorbed by the nanotube material.

9. The surface acoustic wave CO₂ gas sensor of claim 8, wherein said nanotube material is comprised of at least one material from the group comprising: heteropolysiloxane, nano-crystalline, BaTiO₃, CeO₂, BaCO₃, CuO, Ag₂SO₄, Na₂CO₃, SnO₂, BaTiO₃, La₂O₃, CaCO₃, CuO—SrTiO₃, CuO—BaSnO₃, CuO—BaTiO₃, Sm₂O₃, and Y₂O₃.

10. The surface acoustic wave CO₂ gas sensor of claim 8, wherein said nanotube material is comprised of a combination of at least two materials from the group comprising: carbon, silicon, semiconducting oxides, gallium-nitride, and silver.

11. The surface acoustic wave CO₂ gas sensor of claim 8 wherein said SAW device is further comprised of SiO₂ protective layer disposed on top of two metallic interdigital transducers to prevent them from shorting with each other or with said nanotube material deposited between said two metallic interdigital transducers.

12. The surface acoustic wave CO₂ gas sensor of claim 8 wherein said surface acoustic wave sensor is provided in the form of a Rayleigh SAW (R-SAW) device.

13. The surface acoustic wave CO₂ gas sensor of claim 8 wherein said surface acoustic wave sensor is provided in the form of a shear horizontal SAW (SH-SAW) device.

14. The surface acoustic wave CO₂ gas sensor of claim 8 wherein said nanotube material is comprised of nanotubes formed in at least one of: single-wall orientation, double wall orientation, multi-wall orientation.

15. A method using a surface acoustic wave CO₂ gas sensor to detect CO₂ gas, comprising the steps of:
enabling gases to pass onto the surface acoustic wave CO₂ gas sensor comprised of a piezoelectric substrate, nanotube material deposited directly onto a surface of said piezoelectric substrate, and two metallic interdigital transducers deposited onto the piezoelectric substrate on each side of the nanotube material, said two metallic interdigital transducers adapted to react in operational combination with the nanotube material as a sensor of CO₂ gas when CO₂ gas becomes absorbed by the nanotube material;
CO₂ contained in gas passing onto the surface of said surface acoustic wave CO₂ gas sensor are absorbed by nanotube material formed on said surface acoustic wave CO₂ gas sensor;
surface acoustic wave velocity of said surface acoustic wave CO₂ gas sensor is changed following absorption of CO₂ into said nanotube material; and
generating an output signal corresponding to the change in surface acoustic wave velocity caused by the absorption of CO₂.

16. The method of claim 15 wherein said nanotube material is formed of nanotubes comprised of at least one material from the group comprising: heteropolysiloxane, nano-crystalline, BaTiO₃, CeO₂, BaCO₃, CuO, Ag₂SO₄, Na₂CO₃, SnO₂, BaTiO₃, La₂O₃, CaCO₃, CuO—SrTiO₃, CuO—BaSnO₃, CuO—BaTiO₃, Sm₂O₃, and Y₂O₃.

17. The method of claim 15 wherein said nanotube material is formed of nanotubes comprised of a combination of at least two materials from the group comprising: carbon, silicon, semiconducting oxides, gallium-nitride, and silver.

18. The method of claim 15 wherein said nanotube material is formed of nanotubes further comprising the step wherein said surface acoustic wave CO₂ gas sensor is comprised of SiO₂ protective layer disposed on top of two metallic interdigital transducers to prevent them from shorting with each other or with said nanotube material deposited between said two metallic interdigital transducers.

19. The method of claim 15 wherein said surface acoustic wave CO₂ gas sensor is provided in the form of a Rayleigh SAW (R-SAW) device.

20. The method of claim 15 wherein said surface acoustic wave CO₂ gas sensor is provided in the form of a shear horizontal SAW (SH-SAW) device.
